(19) United States
(12) Patent Application Publication
(10) Pub. No.: US 2018/0126682 A1
(43) Pub. Date: May 10, 2018

(54) Deformation Device and Method for Operating a Deformation Device

(71) Applicant: Fiessler Elektronik GmbH & Co. KG, Esslingen (DE)

(72) Inventors: Lutz FIESSLER, Aichwald (DE); Götz FIESSLER, Esslingen (DE)

(21) Appl. No.: 15/809,844

(22) Filed: Nov. 10, 2017

(30) Foreign Application Priority Data
Nov. 10, 2016 (EP) 16198229.3

(51) Int. Cl. B30B 15/04; B21D 55/00; F16P 3/14

(52) U.S. Cl. CPC B30B 15/045; F16P 3/144; B21D 55/00

(57) ABSTRACT

Deformation device with a machine frame on which a pair of tools is arranged, wherein one of the tools is arranged on the machine frame so as to be relatively movable along a movement path and the tools form a size-variable working gap and wherein a first optical safety device is assigned to the movable tool, the safety device comprises a first beam source to provide a first beam bundle parallel to the end surfaces of the tools and a first light receiver to receive the first beam bundle wherein a second optical safety device is assigned to one of the tools, the second optical safety device comprises a second beam source to provide a second beam bundle and a second light receiver to receive the second beam bundle to secure a side surface of the tool aligned normal to the movement path and bordering on the end surface.

### CROSS REFERENCE TO RELATED APPLICATIONS

This application claims foreign priority under 35 U.S.C. §119(a)-(d) to Application No. EP 16198229.3 filed on Nov. 10, 2016, the entire contents of which are hereby incorporated by reference.

### TECHNICAL FIELD

The invention relates to a deformation device with a machine frame on which a pair of tools is arranged, wherein at least one of the tools is arranged on the machine frame so as to be relatively movable along a movement path and end surfaces of the tools arranged opposite each other form a size-variable working gap and wherein a first optical safety device is assigned to one of the tools, in particular to the movable tool, to secure the working gap, wherein the first optical safety device comprises a first beam source to provide a first beam bundle parallel to the end surfaces of the tools and a first light receiver to receive the first beam bundle. The invention also relates to a method for operating a deformation device.

### BACKGROUND

The object of the invention is to provide a deformation device as well as a method for operating a deformation device by which improved security of an operator can be ensured.

This object is achieved for a deformation device with a machine frame on which a pair of tools is arranged wherein at least one of the tools is arranged on the machine frame so as to be relatively movable along a movement path and wherein end surfaces of the tools arranged opposite each other form a size-variable working gap and wherein a first optical safety device is assigned to one of the tools to secure the working gap, wherein the safety first optical device comprises a first beam source to provide a first beam bundle parallel to the end surfaces of the tools and a first light receiver to receive the first beam bundle and with a second optical safety device which is assigned to one of the tools, the second optical safety device comprises a second beam source to provide a second beam bundle and a second light receiver to receive the second beam bundle to secure a lateral surface of the tool aligned normal to the movement path and bordering on the end surface. With the aid of the second optical safety device, additional security of the surrounding of the tool, in particular the movable tool, which cannot be detected with the first optical safety device, should be ensured.

In this case, a space portion facing the user is of particular interest, which is delimited by a horizontally aligned working plane establishing the working gap and a lateral surface of the tool, in particular the movable tool wherein the lateral surface can also be designated as the front side and rear side or as the largest surface of the tool, in particular the upper tool. For example, a danger to the user may occur in this space portion for the case where the deformation device is formed as a bending press for sheet metal and an already pre-formed sheet metal part with a portion initially protruding upwards in a vertical direction should be deformed in a further bending operation. In the course of this further bending operation, the sheet metal part is bent by the interaction of the two tools in the working gap whereby the portion initially protruding upwards is moved on a circular path in the direction of the front side of the tool, in particular the movable tool. In this case, the danger arises where a user who grips the sheet metal part at the portion initially protruding upwards for the purposes of stabilisation, suffers contusions to his hands, insofar as the portion initially protruding upwards approximates the front side of the tool, in particular the movable tool during the deformation movement. This potential danger to the user can be detected with the aid of the second optical safety device in order to switch off the deformation device prior to an actual risk to the user.

Alternatively, the second optical safety device can be used to secure a space portion, facing away from the user, between an adjustable workpiece stop and the lower tool, in particular arranged fixed on the machine frame. In this case, it must be considered that a workpiece stop of this type for small workpieces can be adjusted up to directly before the lower tool in particular arranged fixed on the machine frame and in this case there is a risk of crushing the fingers of the user.

It is expedient for the second optical safety device to be arranged on the machine frame or on the movable tool together with the first optical safety device adjustable along the movement path and to be designed for securing a front side of the tool, in particular the movable tool facing the user. By coupling the two safety devices, simple construction of the deformation device is ensured. This is in particular the case when a position of the first safety device can be determined with the aid of a position system in particular integrated into the first safety device since in this case, the position of the second safety device is also known without additional measures.

It is preferred for the second beam source to be designed to provide beams at least in a safety area having a box-shaped extension whose largest surface is arranged at a predefined distance to the front side of the tool, preferably the upper tool, in particular the movable tool and for the second beam source and the second light receiver to be arranged at opposing narrows sides of the safety area. To secure the working gap with the aid of the first optical safety device, one or a plurality of light beams aligned parallel to an end surface of the tool is usually used since the region to be secured is relatively small. In contrast, the second optical safety device must secure a significantly larger area volume which in practice takes place with a beam bundle made up of a number of light beams which are sent from the second beam source and establish a box-shaped safety area such that a sensor signal, provided by the second light receiver, always changes by a value when a user enters the safety area, the value allowing it to be reliably recognised when the user enters. The second optical safety device is preferably designed such that vertically-aligned outer edges of the two largest surfaces of the safety area aligned parallel to each other are arranged parallel to the movement path and horizontally-aligned outer edges of the largest surfaces are aligned parallel to the end surface of the tool. Furthermore, it is preferred for the second beam source and the second light receiver to be arranged at narrow sides of the safety area whose longest edge extends parallel to the movement path in the vertical direction. The distance of the safety area from the front side of the tool can be selected so as to negligible. In practice, the distance of the safety area from the front side of the tool is at least a few centimetres in order that for example local protrusions on the front side of the tool, which could lead to shadowing of the beam bundle of the second beam source, do not protrude into the safety area. A distance between the largest surfaces of the safety area and thus an elongation of the safety area in the normal direction with respect to the front side of the tool can also be accepted with a few centimetres.

In one advantageous further development of the invention, the first optical safety device and the second optical safety device are coupled together with a drive device, which is designed for a relatively-movable mounting of the two optical safety devices on the machine frame or on the movable tool. It can be hereby ensured that a positioning for the two optical safety devices is quickly adapted depending on the geometry of the workpiece to be manufactured. It is advantageous when the two optical safety devices can be displaced when the deformation operation is being performed for the workpiece along the movement path in order to for example enable monitoring of the working gap with the aid of the first optical safety device directly before the moment the workpiece is clamped in the working gap and to subsequently be displaced upwards with increasing deformation of the workpiece for example in the vertical direction in order to ensure complete as possible coverage of a risk region by the second optical safety device.

In a further configuration of the invention, the drive device for the two optical safety devices is designed from the group of: electric linear actuators, in particular thread spindle drive, pneumatic linear actuators, in particular pneumatic cylinders, hydraulic linear actuators, in particular hydraulic cylinders.

It is advantageous for an optical axis of the second beam source to be pivoted around a pivot axis aligned parallel to the movement path such that the optical axis adopts a predefinable angle with the front side of the movable tool. By way of this measure, marginal beams, which are emitted by the second beam source at a certain angle to the optical axis, are prevented from reflecting on the front side of the tool and thus possibly impairing the sensitivity of the second optical safety device. For example, the optical axis of the second beam source in relation to the front side of the tool is pivoted by a value of a few degrees, for example 2 to 4 degrees around the pivot axis aligned parallel to the movement path.

It is preferred for the second optical safety device to be assigned to a lower tool and to be designed to secure a space portion bordering on a rear side of the lower tool that faces away from the user. Monitoring of a space portion between the rear side of the tool facing away from the user and an adjustable workpiece stop is hereby enabled. This second optical safety device can additionally or alternatively be used for a further second optical safety device which is provided to secure the front side of the movable tool.

It is expedient for the first optical safety device and the second optical safety device to be connected with a safety controller which is designed to provide drive energy to a tool drive as a function of sensor signals of the two safety devices wherein the tool drive is designed to provide a working movement for the movable tool. The object of the safety controller is on the one hand to regularly, in particular securely request sensor signals of the two optical safety devices. The safety controller is preferably designed such that it only provides drive energy to the tool drive when plausible sensor signals from both optical safety devices are present. Furthermore, the safety controller is configured such that it carries out a comparison of the deviation with a predefinable threshold value in the case of deviations in the sensor signals of at least one of the two safety devices and stops providing drive energy to the tool drive, if the deviation exceeds the threshold value in the sensor signal.

In a further configuration of the invention, the safety controller is designed for controlling the two safety devices according to a predefinable time sequence, preferably at sequential, in particular partially overlapping time intervals. In this further development of the invention, the actual processing operation is considered which can be carried out with the aid of the deformation device. In this case, it may be disruptive under certain circumstances for both safety devices to be operating intermittently such that the safety controller is designed to activate and deactivate the two safety devices in a predefinable time sequence.

In an advantageous further development of the invention, the second light receiver comprises a plurality of light-sensitive sensor elements, in particular in series along the movement path and the safety controller is designed to distinguish interruptions of the beam bundle based on predefinable interruption criteria. The sensor elements are preferably arranged to form a line sensor wherein adjacently arranged sensor elements have a minimum distance to each other in order to enable the most complete and continuous detection of light beams which establish the narrow side of the safety area and impinge upon the second light receiver.

In a further development of the invention, an optical element, in particular a lens is assigned to each of the sensor elements in order to enable enlargement of the detection region for the respective sensor element.

In a further configuration of the invention, the safety controller is connected to a drive device for a workpiece stop and is designed to provide drive energy to the drive device as a function of sensor signals of the second safety device wherein the drive device is designed to provide an actuating movement of the workpiece stop with respect to a rear side of a lower tool facing away from the user. It is preferred for the safety controller to interrupt at least the provision of drive energy to the drive device as soon as a sensor signal of the second safety device signals a user entering the space portion between a rear edge of the lower tool and the front edge of the workpiece stop in order to thereby prevent a crushing risk to the user.

### SUMMARY

The object of the invention is achieved for a method to operate a deformation device with the following steps: moving a first tool arranged movably on a machine frame along a movement path in the direction of a second tool arranged rigidly on the machine frame to reduce a size-variable working gap delimited by opposingly arranged end surfaces of the tools, monitoring the working gap with a first optical safety device which provides a first beam bundle which is aligned parallel to the end surfaces of the tools and which is detected by a first light receiver, monitoring a safety area which is located at a distance to a side surface of a tool, with a second optical safety device which provides a beam bundle which establishes the safety area which is detected by a second light receiver wherein the two light receivers each provide a sensor signal to a safety controller which interrupts the provision of drive energy to a tool drive, which is designed to provide a working movement for the movable tool, when an interruption of the respective beam bundle causes a change of the respective sensor signal which is larger than a predefinable threshold value.

In a further configuration of the method, the second optical safety device is at least partially deactivated when a distance between the end surfaces of the tools falls short of a predefinable distance value. This approach can be provided when the second optical safety device secures a space portion which borders directly on the side surface of the tool and is thus arranged so close to the side surface of the tool that the user can no longer manually enter the space portion when the workpiece is imminently going to penetrate into this space portion since the gap between tool and side surface is already too small.

In an alternative configuration of the method, the second optical safety device is at least partially activated when a distance between the end surfaces of the tools falls short of a predefinable distance value. In the case of a light grid, which is constructed from a plurality of beam sources and light receivers arranged opposite each other, wherein a beam bundle of a beam source is directed at the opposingly arranged light receiver and wherein the beam sources and light receivers laterally delimit the space portion to be monitored, the beam sources that are not interrupted during a deformation operation for the workpiece to be processed are preferably activated. This activation takes place particularly preferably at a time when the workpiece approaches the side surface of the tool during the deformation operation such that a crushing risk, for example to the hand of a user, could occur.

In a further configuration of the method, the safety controller interrupts the provision of drive energy to the tool drive and/or to a drive device for a tool stop when a user is detected entering a space portion secured by the respective beam bundle based on an at least partial interruption of the respective beam bundle, in particular when there is a change of the sensor signal of the respective light sensor by a predefinable value, at least 20 percent.

### BRIEF DESCRIPTION OF THE DRAWINGS

An advantageous embodiment of the invention is represented in the drawing. In this case, they show:

FIG. 1 is a front view of a deformation device with two optical safety devices whose components are arranged at both sides on the machine frame,

FIG. 2 is a lateral sectional representation of the deformation device according to FIG. 1, and

FIG. 3 is a schematic top view on the deformation device.

### DETAILED DESCRIPTION

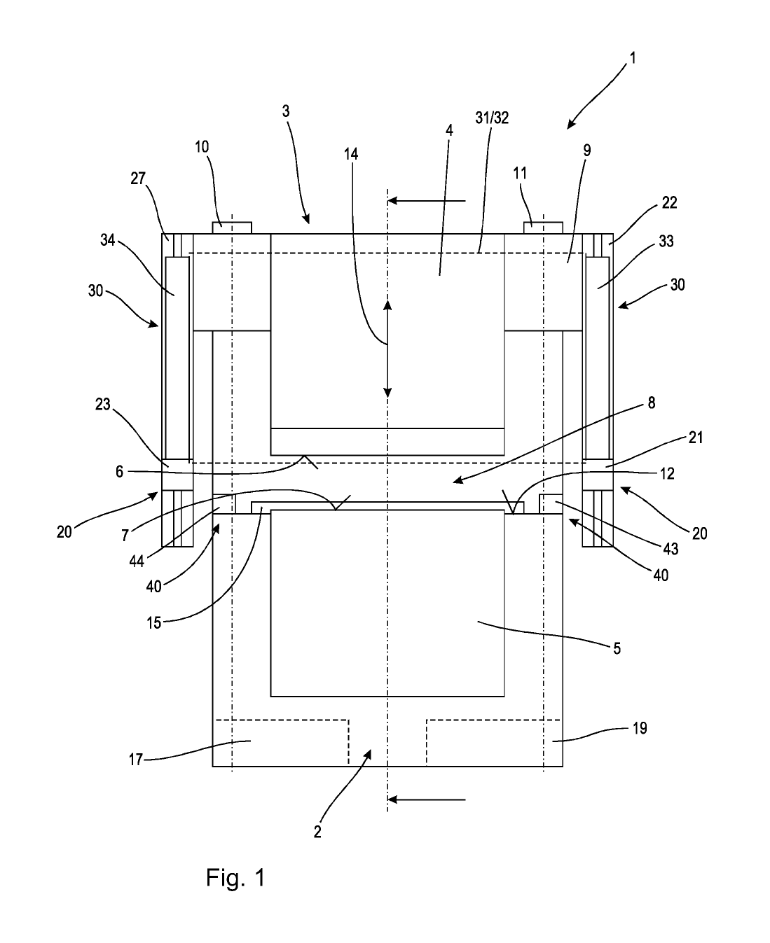

A deformation device 1 represented purely schematically in FIGS. 1 to 3 comprises a machine frame 2 on which a pair of tools 3 is arranged. The deformation device 1 is designed, purely as an example, as a bending press and allows sheet metal parts to be deformed, for example by bending between an upper tool 4 and a lower tool 5 of the pair of tools 3. For example, both the upper tool 4 and the lower tool 5 are designed as a plane-parallel plate which are provided with a corresponding profile at end surfaces 6, 7 located opposite each other. The two end surfaces 6, 7 of the upper tool 4 and the lower tool 5 delimit the working gap 8 of the pair of tools 3. As an example, the lower tool 5 is fixed stationary on the machine frame 2, while the upper tool 4 is movably received on the machine frame 2 and to this end is fixed via a tool holder 9 to two support columns 10, 11 mounted in a height-adjustable manner on the machine frame 2. As an example, the support columns 10, 11 are piston rods of hydraulic cylinders which are housed in the machine frame 2 and which allow the upper tool 4 to be adjusted in a vertical position along a movement path 14 which, purely by way of example, is aligned in a vertical direction. In an embodiment not represented, both tools are designed in a height-adjustable manner. In the case of an embodiment that is also not represented, only the lower tool is designed in a height-adjustable manner.

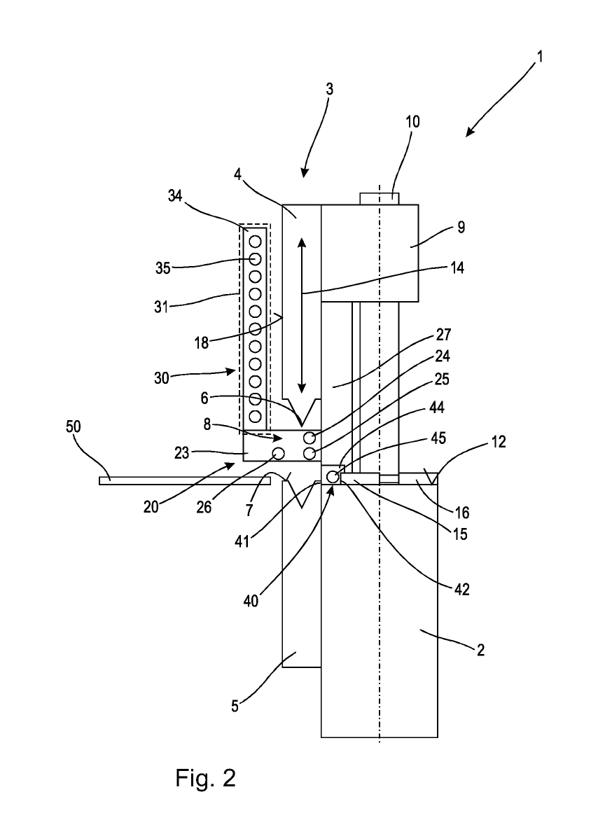

As can be seen from FIG. 1, the upper tool 4 and the lower tool 5 are configured with a narrower width than the machine frame 2. A workpiece stop 15 arranged on an upper side 12 of the machine frame 2 and represented in a purely exemplary manner can be moved closer to or away from the working gap 8 with the aid of a compactly designed hydraulic cylinder 16 which is shown in greater detail in FIG. 2 in order to serve as a depth stop for a workpiece 50 as is represented in FIG. 2.

The deformation device 1 is, according to the representations of FIGS. 1 and 2, equipped with three optical safety devices 20, 30, 40 in total, which are explained in greater detail below. Each of the three optical safety devices 20, 30, 40 is designed to monitor a predefinable, in particular box-shaped space portion in which there would be a risk to the user when the user enters at least during certain operational phases of the deformation device 1.

The first optical safety device 20 is designed to monitor the working gap 8 and comprises a first beam source 21 which is designed to provide three light beams in total, in particular laser beams which are not represented. The first beam source 21 is coupled to an actuator device 22 which is designed, by way of example, as an electrically-operable thread spindle drive which is not represented in further detail and allows a vertical positioning of the first beam source 21 relative to the tool holder 9 and the upper tool 4 arranged thereon to be changed. Since the actuator device 22 is coupled with the tool holder 9, the first beam source 21 always carries out the movement of the tool holder 9, provided a concordant or inverse movement overlap does not take place by way of corresponding actuation of the actuator device 22. The actuator device 22 is, in a manner not represented in greater detail, electrically connected to a safety controller 17 which is represented purely schematically and designed, for example, as a separate component, but which can also be integrated in the first optical safety device 20 which is designed for positioning the first beam source 21. A first light receiver 23 is arranged opposite the first beam source 21, the first light receiver comprising, by way of example, three sensor elements 24, 25 and 26. Each of the sensor elements 24, 25 and 26 is designed to receive a corresponding light beam provided by the first beam source 21 and not represented in greater detail. In order to always ensure positioning of the first light receiver 23 opposite the first beam source 21, the first light receiver 23 is arranged on an actuator device 27 in the same manner as the first beam source 21, the actuator device being electrically connected to the safety controller 17 in a manner not represented in greater detail and can be actuated by the safety controller 17 synchronously to the actuator device 22. Furthermore, both the first beam source 21 and the first light receiver 23 are electrically connected to the safety controller 17 in a manner not represented in greater detail which, on the one hand, selectively actuates the light sources of the first beam source 21 that are not represented in greater detail and, on the other hand, evaluates sensor signals of the sensor elements 24, 25, 26 of the first light receiver 23.

The second optical safety device 30 is provided to monitor a safety area 31 that is represented purely schematically in FIG. 1, the safety area comprising a square shape and extending with the largest surface parallel to a front side 18 of the upper tool 4. In this case, the longest edge 32 of the largest surface of the safety area 31 runs in the horizontal direction between the second beam source 33 and the second light receiver 34, while a side edge of the largest surface of the safety area 31 extends in a vertical direction parallel to the movement path 14. The second light receiver 34 represented in FIG. 2 borders on a narrow side of the safety area 31, whose surface is delimited by the side edge of the safety area 31 and by a horizontally-running upper edge as well as a horizontally-running lower edge of the safety area 31.

The second beam source 33 is designed to provide a light grid or light curtain in the direction of the second light receiver 34. The light beams of the second beam source 33 establish the safety area 31 such that it is ensured for each area volume portion of the safety area 31 that when a finger or a hand of a user enters, the light beams received from the sensor elements 35 of the second light receiver arranged in a row are switched off, the light beams becoming noticeable in a significantly changed sensor signal of the light receiver 34. To evaluate the sensor signal, the second light receiver 34 is electrically connected, in a manner not represented in greater detail, to the safety controller 17. Furthermore, the second beam source 33 is also electrically connected, in a manner not represented in greater detail, to the safety controller 17 in order to allow the light beams that are supposed to establish the safety area 31 to be selectively powered or switched off.

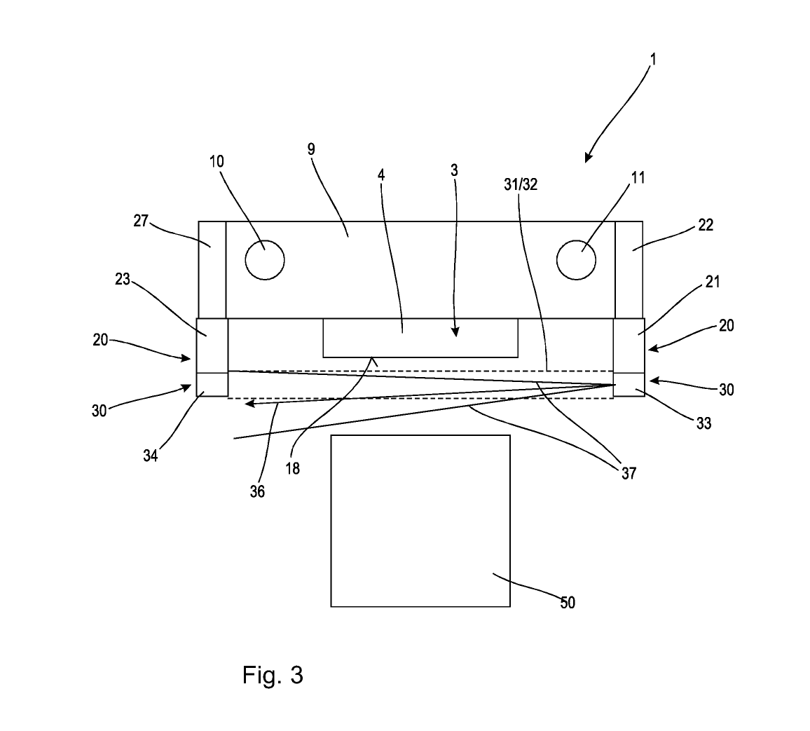

As can be seen from FIG. 3, an optical axis 36 of the second beam source 33 is aligned at an acute angle to a space between the second beam source 33 and the second light receiver 34 in order to prevent reflections from marginal light beams 37 to the front side 18 of the upper tool 4.

In the embodiment of the deformation device 1 represented in FIGS. 1 to 3, a third optical safety device 40 is provided, purely as an example, to secure a space region between a rear side or rear edge 41 of the lower tool 5 and a front side or front edge 42 of the workpiece stop 15. The third optical safety device 40 comprises a third beam source 43 as well as a third light receiver 44 which are arranged opposite each other stationary on the machine frame 2. In this case, the third beam source 43 is designed to provide a light beam, in particular a laser beam not represented in greater detail which is aligned parallel to the end surface 7 of the lower tool 5 and on which a sensor element 45 of the third light receiver 44 impinges, if there is no obstacle arranged between the third beam source 43 and the third light receiver 44. The third beam source 43 and the third light receiver 44 are electrically connected, in a manner not represented in greater detail to the safety controller 17, which is designed to selectively activate and deactivate the third beam source and to process the sensor signal provided by the third light receiver 44. If there is an interruption of the optical path between the third beam source 43 and the third light receiver 44 when the third beam source 43 is activated, the third light receiver 44 does not provide the sensor signal which would have to occur without interrupting the optical path. As a result, the safety controller 17 recognises a deviation between a target value for the sensor signal and the actual value of the sensor signal and must therefore assume a danger to a user such that the hydraulic supply for the hydraulic cylinder 16 and preferably also a hydraulic supply for the movement of the support columns 10, 11 is shut off to prevent the potential of danger.

The following approach can be provided for operating the deformation device 1: the deformation device 1 is initially programmed with a memory-programmable controller (SPS) 19 which is electrically connected to the safety controller 17 in a manner not represented in greater detail and which comprises an input device, for example a keyboard, not represented in greater detail, to input programming commands. In the course of programming the deformation tool 1, it can be for example determined up to what distance the upper tool 4 is supposed to be moved to the lower tool 5 in order to deform the workpiece 50 to be received between the two tools 4, 5 in the desired manner. Furthermore, in the course of programming, positioning for the workpiece stop 15 is also determined which is subsequently set during the operation of the deformation device 1 with the aid of the controller 19 and the hydraulic cylinder 16. During this setting operation, the third beam source 43 is activated by the safety controller 17 and the sensor signal of the third light receiver 44 is processed by the safety controller 17 in order to be able to switch off the hydraulic supply for the hydraulic cylinder 16 when the optical path between the third beam source 43 and the third light receiver 44 is interrupted and thus to remove a potential of danger for a user.

After successful positioning of the workpiece stop 15, the third beam source 43 is deactivated and the sensor signal of the third light receiver 44 is not processed further in the safety controller 17.

Since, during the programming of the controller 19, specifications are also made with respect to the upper tool 4 and the lower tool 5, the safety controller 17 can set a position of the two optical safety devices 20 and 30 coupled to the actuator device 22 so that they are located in a favorable position for the subsequent processing operation.

In a subsequent step, the supply of the workpiece 50 by an operator, not represented, can now take place. For example, the operator pushes the plate-shaped workpiece 50 in a horizontal direction into the working gap 8 wherein the workpiece 50 is placed on the end surface 7 of the lower tool 5 and is pushed into the working gap 8 in the horizontal direction in the direction of the workpiece stop 15 until an end face of the workpiece 50 abuts on the workpiece stop 15.

The user can then use a foot switch, not represented, to cause the upper tool 4 to move closer to the lower tool 5 and reduce the working gap 8. In this case, the actuator drive for the support columns 10, 11, not represented, and the upper tool 4 coupled thereto are supplied by the controller 19 with the interconnection of the safety controller 17 in order to effect a linear movement of the upper tool 4 along the movement path 14 in the direction of the lower tool 5. In this phase, the two optical safety devices 20 and 30 are moved synchronously to the upper tool 4 wherein the working gap 8 is secured in a known manner with the aid of the first optical safety device 20 and when the upper tool 4 is moved closer to the lower tool 4 [sic], the individual light sources of the first beam source 21 are shut off little by little and sensor signals of the assigned sensor elements 24, 25, 26 of the first light receiver 23 are faded out in the safety controller 17.

For example, while the upper tool 4 moves closer to the lower tool 5, the second optical safety device 30 is not activated and it is only activated when the workpiece 50 is clamped between the upper tool 4 and the lower tool 5 without deformation of the workpiece 50 already having occurred.

In any case, the second optical safety device 30 is activated by the safety controller 17 as soon as the workpiece 50 is clamped between the upper tool 4 and the lower tool 5 and the deformation operation begins. When the second optical safety device 30 is activated, light beams are emitted from the second beam source 33 such that they completely fill the safety area 31 and impinge upon the sensor elements 35 of the second light receiver 34. In this case, the safety controller 17 is designed to evaluate a sensor signal of the second light receiver 34 such that deviations of the sensor signal, which exceed a predefinable threshold value, lead to a power supply being switched off by the safety controller 17 in order to prevent further movement of the upper tool 4. The sensitivity of the safety controller 17 for the sensor signals of the second light receiver 34 is preferably set such that a distinction can be ensured between a workpiece being reduced in the context of the deformation operation in the safety area 31 and a user manually entering the safety area 31 and the movement of the upper tool 4 being switched off only in the latter case.

If necessary, the group of the two optical safety devices 20 and 30 can, with the aid of the assigned actuator devices 22, 27, also be displaced from the position, which had been adopted during approximation of the upper tool 4 to the lower tool 5 up to the clamping of the workpiece 50, during the further deformation operation for the workpiece 50, for example upwards in the vertical direction and thus towards the closing direction of the upper tool 4 in order to allow a higher safety area 31 to be reliably monitored.

What is claimed is:

1. A deformation device comprising:
first and second tools;
a machine frame on which the first and second tools are arranged, at least one of the first and second tools being arranged on the machine frame so as to be relatively movable along a movement path, wherein end surfaces of the first and second tools arranged opposite each other form a size-variable working gap;
a first optical safety device assigned to one of the first and second tools to secure the working gap, the safety first optical device comprising: a first beam source to provide a first beam bundle parallel to the end surfaces of the tools; and a first light receiver to receive the first beam bundle; and
a second optical safety device assigned to one of the first and second tools, the second safety device comprising: a second beam source to provide a second beam bundle; and a second light receiver to receive the second beam bundle to secure a side surface of the tool to which the second optical safety device is assigned, aligned normal to the movement path and bordering on the end surface of the tool to which the second optical safety device is assigned.

2. The deformation device according to claim 1, wherein the second optical safety device is arranged on the machine frame or on a movable one for the first and second tools together with the first optical safety device, and the optical safety devices are adjustable together along the movement path, wherein the second optical safety device is designed for securing a front side of the tool facing the user.

3. The deformation device according to claim 2, wherein the second beam source is designed to provide beams at least in a safety area having a box-shaped extension whose largest surface is arranged at a predefinable distance to the front side of the tool and in that the second beam source and the second light receiver are arranged at opposing narrows sides of the safety area.

4. The deformation device according to claim 2, further comprising a drive device that couples together the first optical safety device and the second optical safety device, the drive device being designed for a movable mounting of the first and second optical safety devices on the machine frame or on a movable one of the first and second tools.

5. The deformation device according to claim 4, wherein the drive device for the first and second optical safety devices is chosen from the group of: electric linear actuators, thread spindle drives, pneumatic linear actuators, pneumatic cylinders, hydraulic linear actuators, and hydraulic cylinders.

6. The deformation device according to claim 2, wherein an optical axis of the second beam source is pivoted around a pivot axis aligned parallel to the movement path such that the optical axis adopts a predefinable angle with the front side of a moveable one of the first and second tools.

7. The deformation device according to claim 1, wherein the second optical safety device is assigned to a lower tool of the first and second tools and is configured to secure a space portion bordering on a rear side of the lower tool that faces away from the user.

8. The deformation device according to claim 1, further comprising a safety controller, wherein the first optical safety device and the second optical safety device are connected with the safety controller, the safety controller being configured to provide drive energy to a tool drive as a function of sensor signals of the two safety devices, wherein the tool drive is configured to provide a working movement for the movable tool.

9. The deformation device according to claim 8, wherein the safety controller is configured to actuate the first and second safety devices according to a predefinable time sequence.

10. The deformation according to claim 8, wherein the second light receiver comprises a plurality of light-sensitive sensor elements and wherein the safety controller is configured to distinguish interruptions of the beam bundle based on predefinable interruption criteria.

11. The deformation according to claim 8, wherein the safety controller is connected to a drive device for a workpiece stop and is configured to provide drive energy to the drive device as a function of sensor signals of the second safety device, wherein the drive device is configured to provide an actuating movement of the workpiece stop with respect to a rear side of a lower tool of the first and second tools facing away from the user.

12. A method for operating a deformation device, the method comprising:
moving a first tool arranged movably on a machine frame along a movement path in the direction of a second tool arranged rigidly on the machine frame to reduce a size-variable working gap delimited by opposingly arranged end surfaces of the first and second tools;
monitoring the working gap with a first optical safety device which provides a first beam bundle which is aligned parallel to the end surfaces of the first and second tools and which is detected by a first light receiver; and
monitoring a safety area located at a distance to a side surface of one of the first and second tools, with a second optical safety device which provides a beam bundle that establishes the safety area which is detected by a second light receiver, wherein the two light receivers each provide a sensor signal to a safety controller that interrupts the provision of drive energy to a tool drive designed to provide a working movement for the movable tool when an interruption of the respective beam bundle causes a change of the respective sensor signal that is larger than a predefinable threshold value.

13. The method according to claim 12, wherein the second optical safety device is at least partially deactivated when a distance between the end surfaces of the first and second tools falls short of a predefinable distance value.

14. The method according to claim 12, wherein the second optical safety device is at least partially activated when a distance between the end surfaces of the first and second tools becomes smaller than a predefinable distance value.

15. The method according to claim 12, wherein the safety controller interrupts the provision of drive energy to the tool drive and/or to a drive device for a workpiece stop when a user is detected entering a space portion secured by the respective beam bundle based on an at least partial interruption of the respective beam bundle.
